(19) United States
(12) Patent Application Publication
(10) Pub. No.: US 2020/0298037 A1
(43) Pub. Date: Sep. 24, 2020

(54) FLAME ARRESTER

(71) Applicant: Frank HELMSEN, Peine (DE)

(72) Inventor: Frank HELMSEN, Peine (DE)

(73) Assignee: PROTEGO (USA), Inc., Charleston, SC (US)

(21) Appl. No.: 15/544,420

(22) Filed: Jul. 18, 2017

Related U.S. Application Data
(63) Continuation of application No. 13/977,037, filed on Jun. 28, 2013, now abandoned.

(30) Foreign Application Priority Data
Dec. 30, 2010 (DE) 10 2010 056 590.3

(51) Int. Cl. A62C 4/00; F23D 14/82

(52) U.S. Cl. CPC A62C 4/00; F23D 14/82

(57) ABSTRACT

A flashback preventer with a cylindrical flame trap which is installed in a wall, separating an at-risk region from an external region, and has a cross-sectional surface area containing a plurality of throughflow gaps and a height determining the length of the throughflow gaps and an underside directed towards the at-risk region, and an upper side directed towards the external region, can be formed with a low mass and high energy-dissipation efficiency in that the flame trap is inserted into an opening in the wall, said opening corresponding to the cross-sectional surface areas of the flame trap, and has at least a fifth of its height projecting beyond the wall into the external region.

The invention relates to a flame arrester having a cylindrical flame barrier installed in a wall which separates an at-risk region from an external region, said flame barrier having a cross-sectional area having a multiplicity of through-flow gaps and a height determining the length of the through-flow gaps, and also having an underside directed toward the explosive region and a top side directed toward the external region.

Such flame arresters are known in numerous embodiments. They are used wherever a region that is at risk on account of explosive or flammable gases has to be protected from flame propagation into the at-risk region, in order to prevent an explosion disaster in the at-risk region. The at-risk region can be formed by a container in the broadest sense, that is to say also by a pipe which leads to a container or reserve of an explosive or flammable gas.

An important application for flame arresters of the type mentioned at the beginning is formed by valves which serve to vent a container when an excess pressure builds up in the container and has to be released for safety reasons. In this case, gas is let out of the at-risk region through a flame barrier via the valve. In order that the gas has no harmful effect on the environment, it can be ignited immediately after passing through the flame barrier in order in this way to be rendered harmless in terms of its explosivity or flammability by an atmospheric deflagration or by burning off. Valves of this kind can be provided with controlled covers that burn off or melt off and when used are opened in order for the gases to burn off or flare off on the outer side of the flame barrier. Since the burning-off of the gases can last for a relatively long period of time, the flame barrier has to reliably prevent flame propagation even if the burning-off of the gas on the top side continues for a relatively long period of time, for example two hours or more. If the flame barrier is suitable for this purpose, it is referred to as an “endurance burning proof” flame barrier. If, on account of the design, only a brief flame development can occur, a short time burning proof flame arrester is sufficient.

Suitable flame barriers for realizing the present invention are all models which ensure a predetermined maximum gap width and a predetermined minimum gap length. A preferred design is easily achieved by the circular or spiral coiling together of a plain metal strip and a corrugated metal strip, wherein the width of the strips defines the height of the flame barrier and the length of the through-flow gaps formed by the corrugated strip. In this case, it is also possible for a plurality of such flame barriers to be arranged in succession—with or without intermediate spaces or intermediate elements—in the through-flow direction.

Endurance burning proof flame arresters are realized in the known art in that the flame barriers are inserted into stable metal enclosing cages, by way of which heat dissipation which is as good as possible from the flame barrier into the surrounding housing is intended to take place. A considerable metal mass is required for sufficient heat dissipation, which is necessary in order to be endurance burning proof. Furthermore, the length of the through-flow gaps has to be selected such that the burn-off temperature on the outer side as far as the end of the through-flow gap on the underside, which is directed toward the at-risk region, has dropped to such an extent that the explosive or flammable gas present in the at-risk region is reliably no longer ignited there. These conditions cause a considerable material requirement and a considerable space requirement of the flame arrester in question.

Accordingly, it is the object of the present invention to be able to realize a flame arrester of the type mentioned at the beginning in a simpler, less voluminous construction.

In order to achieve this object, according to the invention a flame arrester of the type mentioned at the beginning is characterized in that the flame barrier is inserted into an opening in the wall, said opening corresponding to the cross-sectional areas of the flame barrier, and projects beyond the wall with at least a fifth of its height into the external region.

Thus, the flame barrier according to the invention is not inserted into a stable enclosing cage but merely into an opening in the wall, and then only with a part of its height. This means that the thickness of the wall is in any case much smaller than the height of the flame barrier. At a conventional wall thickness of 8 mm, the height of the flame barrier is therefore at least 10 mm.

According to the invention, the flame barrier projects out of the wall with at least a fifth, preferably at least a third, and more preferably with at least a quarter of its height. The flame arrester according to the invention is particularly effective when that part of the flame barrier that projects out of the wall in the external region makes up at least half, preferably at least two-thirds of its height.

The flame barrier is radially bounded by a thin metal sheet which can be formed by, for example, the plain metal sheet which is coiled together with a corrugated metal sheet to form the flame barrier. However, it is also possible to fasten a similar stabilizing metal sheet, the thickness of which is in any case less than 1 mm, preferably less than 0.5 mm, to the circumference of the cylindrical flame barrier.

The flame barrier formed in this way according to the invention thus needs only to be inserted into the opening in the wall, which is in the form of a plate. The flame barrier according to the invention therefore manages with a small mass since an enclosing cage is not necessary. The heat is emitted both to the gas flowing through and also decisively by heat radiation. Since the flame barrier projects beyond the wall into the external region, specifically preferably with the majority of its height, the flame barrier can emit heat not only via the top side but via the entire lateral wall which projects out of the opening in the wall into the external region. Therefore, it is important for the flame barrier according to the invention that no massive enclosure of the lateral wall takes place, but at most mechanical stabilization is carried out with a metal sheet which surrounds the lateral surface and absorbs the temperature of the circumferential surface largely without losses and without delay, in order in this way to contribute to the emission of the heat from the flame barrier.

The flame barrier according to the invention allows much more effective energy dissipation by heat radiation than by heat conduction into a surrounding enclosing cage. While the heat dissipation into a massive material increases linearly with the temperature difference, the heat dissipation by the heat radiation takes place with the fourth power of the temperature difference (˜ΔT⁴). Furthermore, the mass of the flame barrier that is heated by the burning off of the gas is comparatively small. The flame arrester can thus adapt to very quickly changing flow rates and quickly adopt an equilibrium state by energy absorption from the combustion process and energy emission by heat radiation and heat conduction to the gas flowing through. Since it is important for the effectiveness of the flame arrester according to the invention that as large a part of the height of the flame barrier as possible projects out of the opening in the wall, it is preferred for the flame barrier to terminate with the lower edge of its height flush with the underside, directed toward the at-risk region, of the wall.

In this case, it is expedient for a first fastening element which traverses the cross section of the flame barrier to be fastened to the underside of the wall. This fastening element can ensure that the flame barrier is secured axially without substantially impairing the flow cross section through the flame barrier. For this purpose, the fastening element can be formed, in a preferred embodiment, by a simple rod which is secured to the underside of the wall on both sides of the cross section of the flame barrier.

Alternatively thereto, the fastening element can also be formed by a rib ring known per se or a coarse-meshed screen or woven fabric or a coarse-meshed grating.

Mechanical stabilization, in particular a flame barrier formed by the coiling of a plain strip together with a corrugated strip, is achieved in that the first fastening element is connected via a connecting element that projects through a central opening in the flame barrier to a second fastening element which rests against the top side of the flame barrier. The flame barrier is thus also mechanically stabilized on the top side by the second fastening element, with the second fastening element—on account of the height difference—not having to be connected in a complicated manner to the corresponding top side of the wall, since the connection to the underside of the wall is producible in a stable manner via the connecting element and the first fastening element. Expediently, a single connecting element which is guided centrally through the flame barrier is sufficient. In the case of a coiled flame barrier, the coiling of the plain strip together with the corrugated strip takes place expediently about a winding core in the form of a sleeve. The connecting element can be inserted with a matching fit into the internal space in the sleeve, so as to ensure that no uncontrolled large gap widths for the gas flowing through are formed by the connecting element.

In a first embodiment of the invention, the flame barrier is preferably in the form of a disk having a smaller height compared with a cross-sectional length. The cross section of the disk in this case represents substantially the clear cross section which is provided with the through-passage gaps. In this case, optionally only the cross-sectional area which is taken up by a winding core, optionally in the form of a sleeve closed by the connecting element, is not available for the through-passage gaps.

The large energy dissipation, desired according to the invention, by heat radiation requires that a large free surface of the flame barrier compared with its mass exists. For large flow cross sections of the explosive gas to be dissipated, it is therefore advantageous if, rather than a single large flame barrier being used for this flow cross section, a plurality of smaller flame barriers are introduced into the flow cross section, said smaller flame barriers being inserted into corresponding openings in the wall enclosing the flow cross section. Preference is therefore given to a flame arrester in which a plurality of flame barriers are inserted into the wall which closes off a gas path of the at-risk region.

The flame arrester according to the invention allows for the first time an endurance burning flame arrester even for highly flammable gases, such as hydrogen for example. Therefore, according to the invention, an endurance burning flame arrester suitable for explosion group IIC can be created. Said endurance burning flame arrester may in particular be configured in the form of a flame barrier in the form of an annular cylinder, in the case of which the through-passage gaps extend in an annular space surrounding an internal space. In this case, the internal space is closed off from the at-risk region and is thus connected to the external region.

In this case, it is advantageous if the internal space forms a flow duct for an inert gas, wherein the inert gas may be air drawn in from the external region if that end of the flow duct that is not connected to the internal space is connected to the external region.

Thus, in addition to the effect of heat emission, there is a supporting effect by cooling by means of a flowing inert gas.

In the case of the embodiment of the flame barrier as an annular cylinder, the application focus is on the creation of an endurance burning flame arrester for the most easily flammable gases, wherein the through-flow rate of the explosive or flammable gas through the flame barrier is of subordinate importance. What is essential here is that such cooling sets in over the height of the flame barrier that even the very easily flammable gases are not ignited in the at-risk region. According to the invention, this is even achieved for endurance burning on the top side of the flame barrier in explosion class IIC.

The preferred application of the present invention is in the formation of an endurance burning proof flame arrester, although the construction according to the invention is also advantageous for flame arresters which do not have to be endurance burning proof, in particular short time burning flame arresters and atmospheric deflagration flame arresters. For these applications, a shorter projection of the flame barrier out of the wall into the external region is sufficient, that is to say for example between a fifth and half of the height of the flame barrier, whereas for an endurance burning flame arrester a projection with at least half of the height of the flame barrier is regularly required.

It is clear to a person skilled in the art that the idea of forming a flame barrier of the described type in the form of an annular cylinder with an internal space which can bring about additional cooling of the flame barrier by convection or by way of a forced gas flow can also be of significance for flame barriers which are not inserted in the manner according to the invention into an opening in a wall, but are installed for example in an enclosing cage. The formation of the flame barrier as an annular cylinder in which the through-passage gaps surround an internal space in the described manner is therefore of independent significance.

The invention will be explained in more detail in the following text with reference to exemplary embodiments illustrated in the drawing, in which:

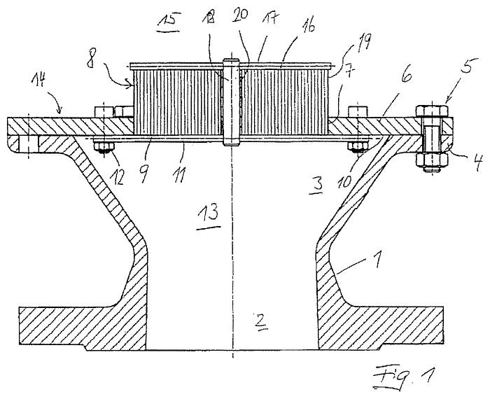

FIG. 1 shows a vertical section through a flame arrester according to a first exemplary embodiment of the invention, having a single flame barrier;

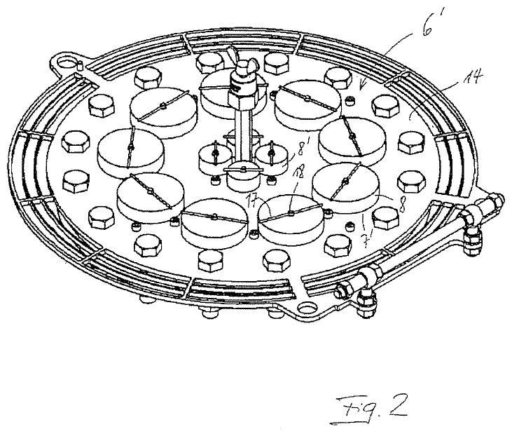

FIG. 2 shows a perspective view obliquely from above of a flame arrester according to a second exemplary embodiment of the invention, having a multiplicity of flame barriers which are mounted on a common wall;

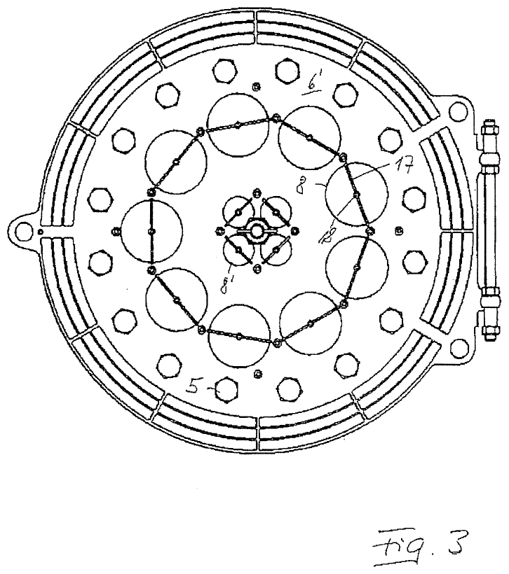

FIG. 3 shows a schematic plan view of the arrangement according to FIG. 2;

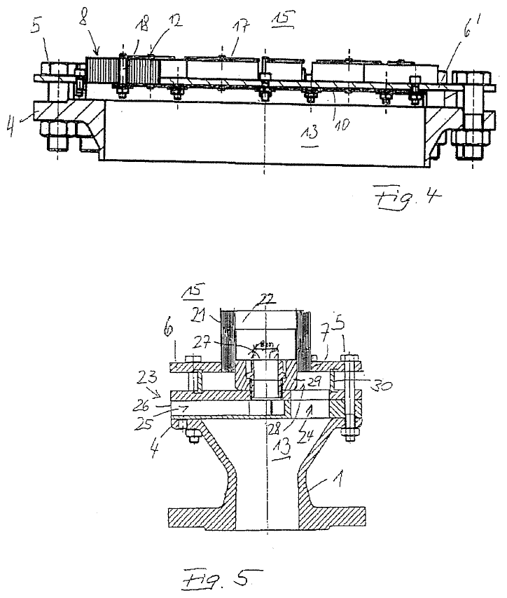

FIG. 4 shows a partial vertical sectional illustration of the arrangement according to FIGS. 2 and 3;

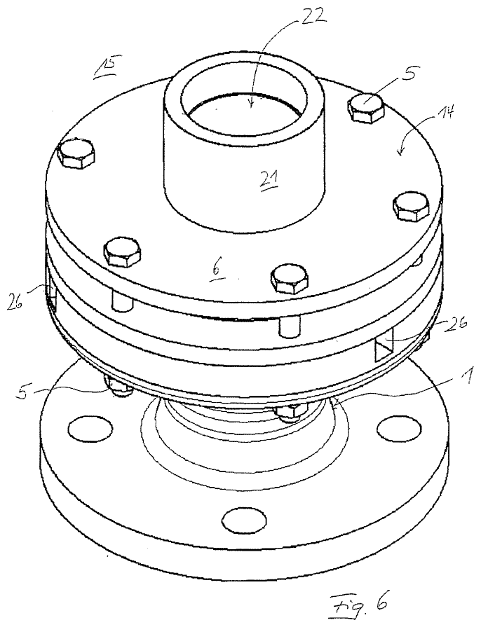

FIG. 5 shows a vertical section through a flame arrester according to a third exemplary embodiment of the invention, having a flame barrier in the form of an annular cylinder;

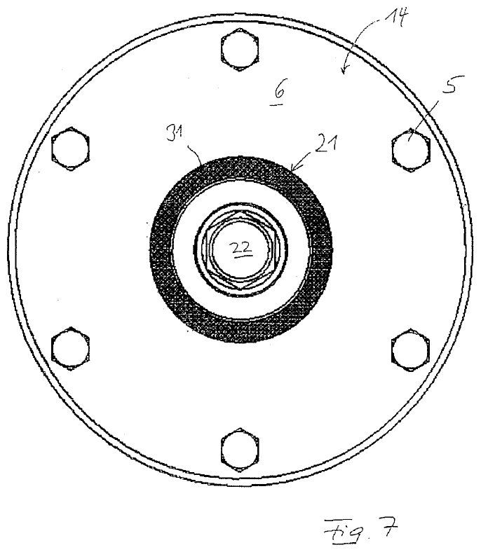

FIG. 6 shows a schematic perspective view obliquely from above of the embodiment according to FIG. 5;

FIG. 7 shows a plan view of the embodiment according to FIG. 5.

FIG. 1 shows a connection part 1 which is not specified in more detail. The connection part 1 merges from a tubular line cross section 2 into a conical enlargement 3 and opens into an annular fastening flange 4. A wall 6 in the form of a metal plate is screwed onto the fastening flange 4 by means of screw connections 5.

In continuation of the tubular line cross section 2, a circular opening 7 is provided in the wall 6, a disk-shaped flame barrier 8 having a circular cross section being inserted into said circular opening such that an underside 9 of the flame barrier 8 is aligned with an underside 10, directed toward the tubular line cross section 2, of the wall 6. A first fastening element 11 in the form of a rod is fastened to the underside 10 of the wall 6 by screw connections 12 and thus rests against the underside 9 of the flame barrier 8.

The tubular line cross section 2 and the conical enlargement 3 form a region 13 at risk on account of explosive or flammable gases, said region being closed off by the wall 6 and the flame barrier 8 inserted with a matching fit into the opening 7 in the wall 6. The top side 14 of the wall that is opposite the underside 10 of the wall 6 is directed toward an external region 15 of the flame arrester, into which the flame barrier 8 projects with a predominant part of its height and is closed off on the end side by way of a top side 16.

Located on the top side 16 of the flame barrier 8 is a second fastening element 17 which is likewise formed by a rod in the exemplary embodiment illustrated in FIG. 1. The rod is plugged through a central opening in a bolt-like connecting element 18. The connecting element 18 projects beyond the underside 9 of the flame barrier and has likewise here a through-opening through which the first fastening element 11 is likewise plugged. By way of the two fastening elements 11, 17, the flame barrier 8 is thus secured in the axial direction, while it is fixed in the radial direction, that is to say with its circumferential wall 19 in the opening 7 in the wall 6.

The circumferential wall 19 of the flame barrier 8 can be formed by a thin metal sheet having a thickness of at most 1 mm and can be fixed to the flame barrier 8 by laser spot-welding or the like.

In a preferred embodiment, the flame barrier 8 is produced in that a plain metal strip is coiled together with a corrugated metal strip onto a winding core 20 such that the corrugations of the corrugated metal strip form, between two coil layers of the plain metal strip, defined through-flow gaps through which gas can flow axially out of the at-risk region 13 into the external region 15. The length of the through-passage gaps is thus determined by the width of the two coiled-together metal strips. The winding core 20 is formed as a sleeve having an axial cavity such that the bolt-like connecting element 18 can be inserted with a matching fit into the internal space of the winding core 20.

FIGS. 2 and 3 show a second embodiment of the invention with a wall 6′ which closes off an at-risk region 13 (FIG. 4). The wall 6′ has nine openings 7′ which are arranged on a circular path and into which flame barriers 8 are inserted with a matching fit, said flamer barriers 8 projecting out of the top side 14 of the wall 6′ with a predominant part of their height and being fixed with a rod-like second fastening element 17 which is fixed to the underside 10 of the wall 6′ by a central bolt-like connecting element 18.

Located in the internal region of the nine flame barriers 8 are four further flame barriers 8′ which are inserted into corresponding openings 7′ in the wall 6′. The flame barriers 8′ have a much smaller diameter than the flame barriers 8. The four flame barriers 8′ are arranged with their central connecting elements 18 likewise on a circular path around a central point of the wall 6′. The wall 6′ is, as shown in FIG. 4, fastened by way of numerous screw connections 5 to an annular fastening flange 4 of a connection part 1.

The flame barriers 8, 8′ are fastened in the same way as was explained with reference to the first exemplary embodiment according to FIG. 1.

The arrangement of the numerous flame barriers 8, 8′ on the wall 6′ affords the advantage that very large parts of the circumferential walls 19 of the flame barriers 8, 8′ project out of the top side of the wall 6′ and form, together with the top sides 16 of the flame barriers 8, large surfaces from which heat is emitted into the external region 15.

The third exemplary embodiment of the invention, illustrated in FIGS. 5 to 7, shows a connection part 1 which is the same as the connection part 1 in FIG. 1. The wall 6 in the form of a plate is fastened to the connection part 1 via screw connections 5 which are configured in a longer manner here. The wall 6 has likewise a circular central opening 7 into which a flame barrier 21 in the form of a circular cylinder is inserted such that within the flame barrier 21 a circular cylindrical internal space 22 which communicates with the external region 15 is produced. Inserted here between the annular fastening flange 4 of the connection part 1 and the wall 6 is an intermediate piece 23 by way of which the guide ducts 24, 25 are formed. One guide duct 24 is connected to the explosive region 13 while one guide duct 25 has a radial end 26, which forms an inlet opening for air from the external region 15, and an axial central end 27 which opens into the internal space 22 of the flame barrier 21.

The guide duct 24, however, continues the explosive region 13 axially and opens into an annular space 28 which is located underneath the annular space which is provided with through-passage gaps by the flame barrier 21 and through which explosive or flammable gas can be blown into the external region 15 in order optionally to be combusted directly there. In this case, a sealing piece 29 ensures that no explosive or flammable gas passes into the internal space 22 of the flame barrier 21. A circumferential wall 30 closes off the annular space 28 radially from the outside.

FIG. 6 illustrates the structure of the flame arrester according to the third exemplary embodiment of the invention in a perspective view. It can be seen that a plurality of mouth openings 26 for drawing in air from the external region 15 can be provided in order to effect additional cooling of the flame barrier 21 by way of a convection flow through the internal space 22 of the flame barrier 21. However, the major part of the cooling of the flame barrier 21 takes place by emission of heat via the large surface of the flame barrier 21 which projects out of the top side 14 of the wall 6 into the external region 15.

FIG. 7 illustrates, again in plan view, an annular cross-sectional area 31 of the flame barrier 21 in which axial through-passage gaps are located close together and are separated from one another by the corrugation of a corrugated metal strip on the one hand and by the coil layers of the plain metal strip on the other hand.

The energy emission by heat radiation at the large surfaces of the hollow-cylindrically formed flame barrier 21 is supported in this embodiment by a convection flow of air out of the external region 15 through the internal space 22 of the flame barrier 21. The heat dissipation from the flame barrier 21 is supported by this convection flow. Of course, it is possible not just to form a self-adjusting convection flow but also to generate a forced flow through the internal space 22 by means of a fan. Furthermore, it is possible to form a flow circulation not with air but with some other inert gas.

Of course, it is also possible to form, with the flame barriers 21, an arrangement in which a plurality of flame barriers 21 are inserted into corresponding openings 7 in the wall 6 in order to provide a higher through-flow capacity.

However, the flame barriers 21 are not optimized for high through-flow capacities but afford high energy emission into the external region 15 such that for the first time an endurance burning proof flame arrester can also be created which is endurance burning proof for gases of explosion group IIC, such as hydrogen for example, for gases of explosion group IIB, and also for other gases having a high energy content. Thus, an endurance burning proof flame arrester for a stoichiometric hydrogen/air mixture composition has successfully been achieved with a flame barrier having a diameter of 65 mm, an internal space 22 having a diameter of 51 mm and a height of 50 mm, with the formation of a maximum gap width of 0.2 mm in the annular cross-sectional surface.

By contrast, in a comparative test, in which the outside diameter of the flame barrier 21 was increased to 75 mm, but the diameter of the internal space 22 and the height were kept at 51 mm and 50 mm, respectively, flame propagation occurred at a maximum gap width of 0.2 mm. Thus, it is clear that, for the explosion group tested here, the dimensioning of the overall flow cross section of the annular cross-sectional area 31 has to be dimensioned carefully in relation to the emitting surfaces of the flame barrier 21, in order to achieve the formation of an endurance burning proof flame arrester for gases even of explosion group IIC.

1. A flame arrester, comprising:
a cylindrical flame barrier;
a wall which separates an at-risk region from an external region,
wherein the wall has a first side facing the at-risk region and a second side facing the external region, and wherein the wall an opening which passes through the wall from the first side to the second side,
wherein the cylindrical flame barrier is inserted within the opening in said wall,
wherein the cylindrical flame barrier has a cross-sectional area having a multiplicity of through-flow gaps and a height determining the length of the through-flow gaps, and
wherein the cylindrical flame barrier has an underside directed toward the at risk region and a top side directed toward the external region,
wherein the flow through gaps of the cylindrical flame barrier project through wall beyond the second side of the wall with at least a fifth of the height of the cylindrical flame barrier extending beyond the second side of the wall into the external region.

2. The flame arrester as claimed in claim 1, wherein the flame barrier has a lower edge flush with the underside of the cylindrical flame barrier, wherein the lower edge is directed toward the at-risk region.

3. The flame arrester as claimed in claim 1, further comprising a first fastening element which traverses the cross section of the flame barrier and fastens the underside of the cylindrical flame barrier to the first side of the wall.

4. The flame arrester as claimed in claim 3, further comprising a second fastening element which rests against the top side of the flame barrier and is connected to the first fastening element via a connecting element that projects through a central opening in the cylindrical flame barrier.

5. The flame arrester as claimed in claim 3, wherein either or both the first and second fastening element is a rod.

6. The flame arrester as claimed in claim 3, wherein the first fastening element is a rib ring.

7. The flame arrester as claimed in claim 1, wherein the cylindrical flame barrier is in the form of a disk having a smaller height compared with a cross-sectional length.

8. The flame arrester as claimed in claim 1, further comprising at least one additional cylindrical flame barrier, and wherein the wall has at least one additional opening, wherein the at least one additional cylindrical flame barrier is inserted into the at least one additional opening in the wall.

9. The flame arrester as claimed in claim 1, wherein the cylindrical flame barrier is in the form of an annular cylinder, wherein through-passage gaps extend in an annular space surrounding an internal space, and wherein the internal space is connected to the external region and is closed off from the at-risk region.

10. The flame arrester as claimed in claim 9, further comprising a flow duct for an inert gas is provided in the internal space.

11. The flame arrester as claimed in claim 10, wherein the flow duct is connected to the external region by way of an end that does not open into the internal space.

12. The flame arrester as claimed in claim 1, wherein the cylindrical flame barriers is configured as of a deflagration flame arrester which is designed to burn off gas flowing through the cylindrical flame barrier.
